(19) United States
(12) Patent Application Publication
(10) Pub. No.: US 2011/0285268 A1
(43) Pub. Date: Nov. 24, 2011

(54) LIGHT-EMITTING DEVICE

(76) Inventor: WEN-SHIN PAN, Taipei City (TW)

(21) Appl. No.: 13/106,855

(22) Filed: May 13, 2011

(30) Foreign Application Priority Data
May 19, 2010 (TW) 99209420

(51) Int. Cl. H01J 61/52; H01K 1/26

(52) U.S. Cl. 313/46; 313/113

(57) ABSTRACT

A light-emitting device for increasing light-emitting efficiency by destroying total reflection includes a substrate unit, a light-emitting unit, a strip light-guiding unit and a cover unit. The light-emitting unit has a plurality of light-emitting modules disposed on the substrate unit. The strip light-guiding unit has a plurality of strip light-guiding elements corresponding to the light-emitting modules and a plurality of strip reflective elements respectively disposed on the strip light-guiding elements. Each strip light-guiding element has a light-inputting surface facing each light-emitting module, a reflective surface and a light-outputting surface, each strip reflective element is disposed on the reflective surface of each strip light-guiding element, and the light-outputting surface is a rough surface for destroying total reflection. The cover unit has a light-permitting cover coupled with the substrate unit for selectively covering the light-emitting unit and the strip light-guiding unit.

### BACKGROUND OF THE INVENTION

1. Field of the Invention

The instant disclosure relates to a light-emitting device, and more particularly, to a light-emitting device for increasing light-emitting efficiency by destroying total reflection.

2. Description of Related Art

The invention of the lamp greatly changed the style of building construction and the lifestyle of human beings, allowing people to work during the night. Traditional lighting devices such as lamps that adopt incandescent bulbs, fluorescent bulbs, or power-saving bulbs have been generally well-developed and used intensively for indoor illumination.

Moreover, compared to the newly developed light-emitting-diode (LED) lamps, these traditional lamps have the disadvantages of quick attenuation, high power consumption, high heat generation, short service life, high fragility, and being not recyclable. Thus, various high-powered LED lamps are created to replace the traditional lighting devices. Among them, tubular LED lamps are gaining popularity for their dimensional resemblance of traditional fluorescent tubes and thus their adoptability to existing lighting devices.

Referring to FIG. 1A, which shows a conventional LED lamp. The conventional LED lamp includes a circuit substrate 1 and a plurality of LEDs 2 serially and electrically disposed on the circuit substrate 1. The LED lamp can generate visible light with luminous efficiency similar to a traditional daylight lamp. However, because each individual LED 2 is separated from each other with a predetermined interval, that light beams generated by the LEDs 2 may not be uniform. For example, the area of the light source intensity under each LED 2 would be a bright zone, and the area of the light source intensity between each two LED 2 would be a dim zone. Thus, the LED lamp of the prior art does not generate uniform illumination. In addition, the bright zone generated by the conventional LED lamp is often too bright for a naked human eye to directly stare at.

In order to solve the abovementioned problems, namely, “non-uniform illumination” and “bright zone too bright for directing sighting of naked eyes,” lamp makers usually add a transparent cover (not shown) under the LED lamp in order to uniform the light beams and decrease the light source intensity. However, this way would decrease the overall light-emitting efficiency of the LED lamp.

FIGS. 1B and 1C illustrate another conventional light-emitting module from two different viewing angles. The prior art provides a light-emitting module that includes a light-guiding bar 3 and an LED 4 disposed beside the light-guiding bar 3. The light beams L generated by the LED 4 projects to the light-guiding bar 3, and then the light beams L are guided by the light-guiding bar 3 to generate downward light-projecting effect. However, referring to FIG. 1C, the light beams L are guided by the light-guiding bar 3 to generate a downward light-projecting area A shown as the hidden line and the downward light-projecting area A has a narrow illumination range, so that the light-emitting module of the prior art can not provides an extensive illumination range.

### SUMMARY OF THE INVENTION

One particular aspect of the instant disclosure is to provide a light-emitting device that can increase light-emitting efficiency by destroying total reflection.

One embodiment of the instant disclosure provides a light-emitting device for increasing light-emitting efficiency by destroying total reflection, including: a substrate unit, a light-emitting unit, a strip light-guiding unit and a cover unit. The light-emitting unit has a plurality of light-emitting modules disposed on the substrate unit. The strip light-guiding unit has a plurality of strip light-guiding elements corresponding to the light-emitting modules and a plurality of strip reflective elements respectively disposed on the strip light-guiding elements. Each strip light-guiding element has a light-inputting surface facing each light-emitting module, a reflective surface and a light-outputting surface, each strip reflective element is disposed on the reflective surface of each strip light-guiding element, and the light-outputting surface is a rough surface for destroying total reflection. The cover unit has a light-permitting cover coupled with the substrate unit for selectively covering the light-emitting unit and the strip light-guiding unit.

Another embodiment of the instant disclosure provides a light-emitting device for increasing light-emitting efficiency by destroying total reflection, including: a substrate unit, a light-emitting unit, a strip light-guiding unit and a cover unit. The light-emitting unit has a plurality of light-emitting modules disposed on the substrate unit for generating first light beams. The strip light-guiding unit has a plurality of strip light-guiding elements corresponding to the light-emitting modules and a plurality of strip reflective elements respectively disposed on the strip light-guiding elements. The cover unit has a light-permitting cover coupled with the substrate unit for selectively covering the light-emitting unit and the strip light-guiding unit. Each strip light-guiding element has a light-inputting surface facing each light-emitting module, a reflective surface for reflecting the first light beams to from second light beams and a light-outputting surface, each strip reflective element is disposed on the reflective surface of each strip light-guiding element, and the light-outputting surface is a rough surface for guiding the second light beams to pass through the light-permitting cover and project outwards.

For example, the substrate unit has a substrate body, a heat-dissipating element disposed on a bottom side of the substrate body and a conductive structure disposed on a bottom side of the heat-dissipating element and electrically connected to the light-emitting unit, and the heat-dissipating element has a heat-dissipating body and a plurality of heat-dissipating fins coupled with the heat-dissipating body and disposed around the heat-dissipating body. The light-emitting unit has a circuit substrate disposed on the substrate unit, and each light-emitting module has at least one LED electrically connected to the circuit substrate. The numbers of the strip light-guiding element and the strip reflective element are two, the two strip light-guiding elements are adjacent to each other, and the two strip reflective elements face each other. The strip light-guiding elements are adjacent to each other, the strip light-guiding unit has a receiving space between the strip light-guiding elements, and the strip reflective elements face the receiving space. The strip light-guiding elements are adjacent to each other and arranged on the same plane, and the light-outputting surfaces of the strip light-guiding elements face the same direction. Each strip light-guiding element has a plurality of micro concave structures formed on the rough surface thereof by etching. Each strip light-guiding element has a plurality of light-guiding microstructures formed on the reflective surface thereof and covered by each strip reflective element. Each strip reflective element is a plate-shaped or U-shaped reflective sheet for covering the reflective surface of each strip light-guiding element. The light-emitting device further comprises a fixing unit having at least one fixing element for tightly coupling the light-permitting cover with the substrate unit, wherein the at least one fixing element has an opening and the light-permitting cover passes through the opening, and the light-permitting cover has an rough structure formed on the outer surface or the inner surface thereof.

Therefore, because the light-outputting surface of each strip light-guiding element may be a rough surface for destroying total reflection, the light-emitting efficiency of the light-emitting device of the instant disclosure may be increased by destroying total reflection. For example, each strip light-guiding element has a plurality of micro concave structures formed on the rough surface thereof by etching; alternatively the rough surface of each strip light-guiding element may be an atomization surface.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1A is a schematic view of the LED lamp showing light source intensity according to the prior art;

FIG. 1B is a lateral, schematic view of the light-emitting module according to the prior art;

FIG. 1C is a schematic view of the light-emitting module generate a narrow downward light-projecting area according to the prior art;

FIG. 2A is one perspective, exploded, schematic view of the light-emitting device for increasing light-emitting efficiency by destroying total reflection according to the first embodiment of the instant disclosure;

FIG. 2B is another perspective, exploded, schematic view of the light-emitting device for increasing light-emitting efficiency by destroying total reflection according to the first embodiment of the instant disclosure;

FIG. 2C is a perspective, assembled, schematic view of the light-emitting device for increasing light-emitting efficiency by destroying total reflection according to the first embodiment of the instant disclosure;

FIG. 3 is a partial, lateral, cross-sectional, schematic view of the light-emitting device for increasing light-emitting efficiency by destroying total reflection according to the second embodiment of the instant disclosure;

FIG. 4A is a front, assembled, schematic view of the light-emitting device for increasing light-emitting efficiency by destroying total reflection according to the third embodiment of the instant disclosure;

FIG. 4B is a lateral, schematic view of one strip light-guiding unit of the light-emitting device for increasing light-emitting efficiency by destroying total reflection according to the third embodiment of the instant disclosure;

FIG. 5 is a front, assembled, schematic view of the light-emitting device for increasing light-emitting efficiency by destroying total reflection according to the fourth embodiment of the instant disclosure;

FIG. 6A is a front, schematic view of another strip light-guiding unit of the light-emitting device for increasing light-emitting efficiency by destroying total reflection according to the instant disclosure; and

FIG. 6B is a lateral, schematic view of another strip light-guiding unit of the light-emitting device for increasing light-emitting efficiency by destroying total reflection according to the instant disclosure.

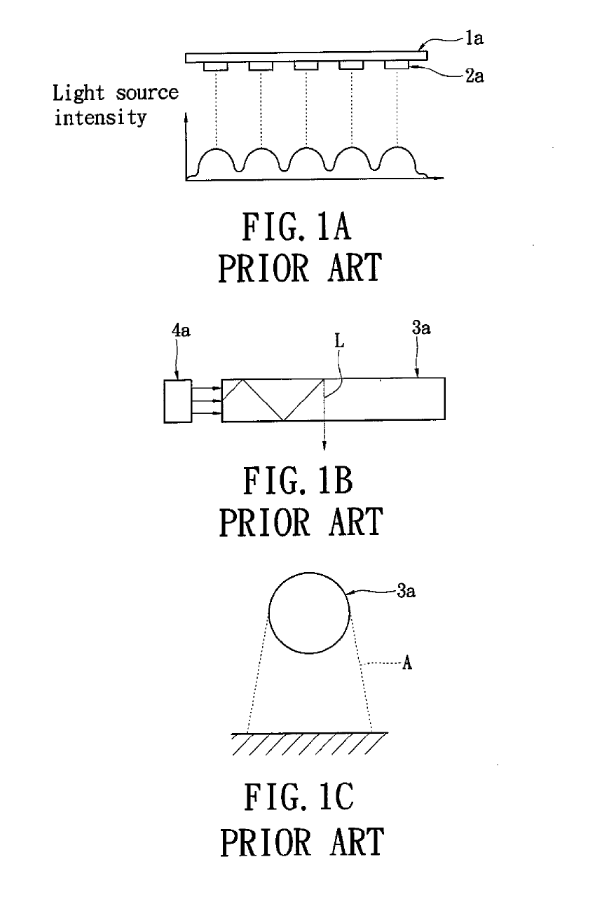

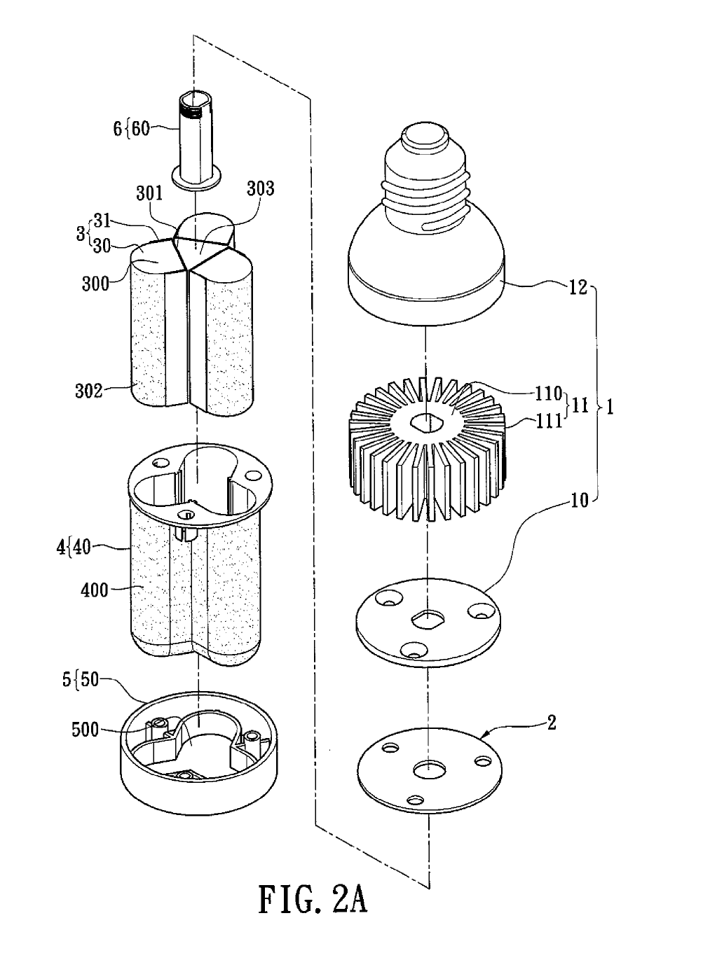

### DETAILED DESCRIPTION OF THE PREFERRED EMBODIMENTS

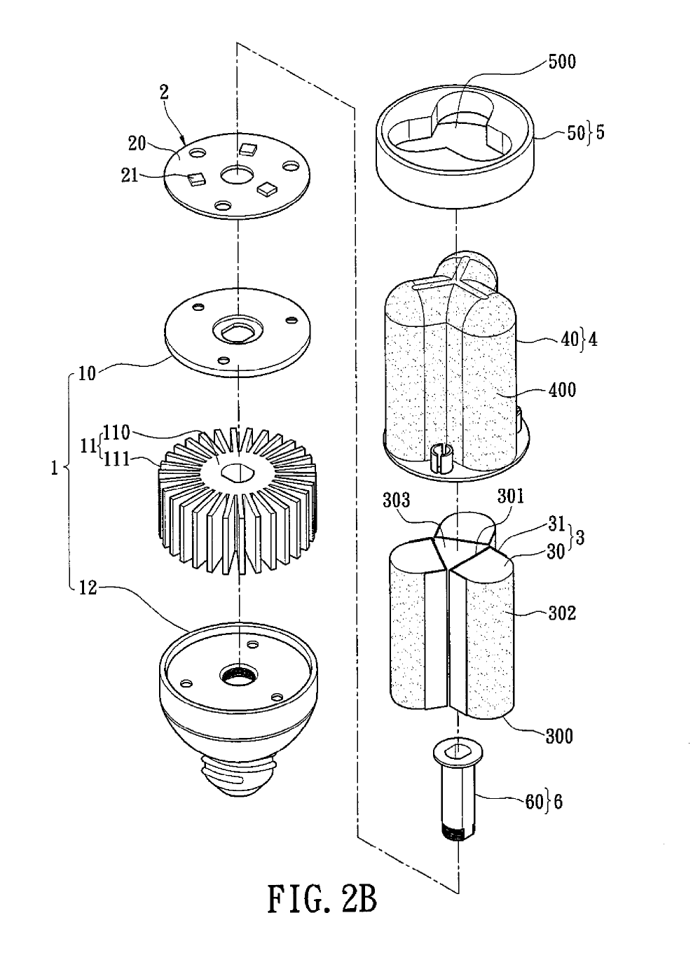

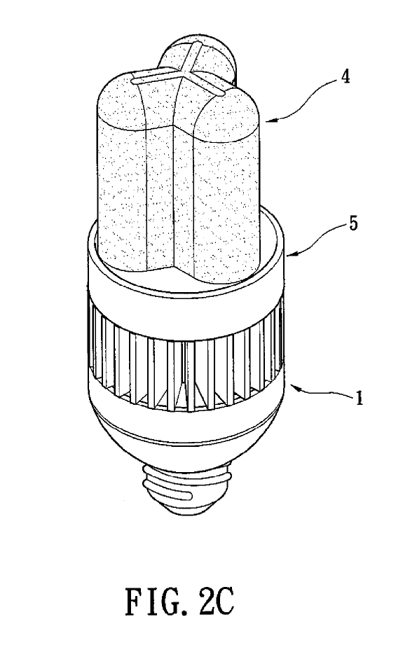

Referring to FIGS. 2A to 2C, the first embodiment of the instant disclosure provides a light-emitting device for increasing light-emitting efficiency by destroying total reflection, including a substrate unit 1, a light-emitting unit 2, a strip light-guiding unit 3 and a cover unit 4.

The substrate unit 1 has a substrate body 10, a heat-dissipating element 11 disposed on a bottom side of the substrate body 10 and a conductive structure 12 disposed on a bottom side of the heat-dissipating element 11 and electrically connected to the light-emitting unit 2. In addition, the heat-dissipating element 11 has a heat-dissipating body 110 and a plurality of heat-dissipating fins 111 coupled with the heat-dissipating body 110 and disposed around the heat-dissipating body 110, and the heat-dissipating fins 111 may be integrated with the heat-dissipating body 110 to form a single piece heat-dissipating structure.

Moreover, the light-emitting unit 2 has a plurality of light-emitting modules 21 disposed on the substrate unit 1. For example, the light-emitting unit 2 has a circuit substrate 20 disposed on the substrate unit 1, and each light-emitting module 21 has at least one LED (Light Emitting Diode) electrically connected to the circuit substrate 20. In other words, the light-emitting module 21 may be disposed on and electrically connected to the circuit substrate 20, and each light-emitting module 21 may be a single LED or composed of many LEDs.

Furthermore, the strip light-guiding unit 3 has a plurality of strip light-guiding elements 30 corresponding to the light-emitting modules 21 and a plurality of strip reflective elements 31 respectively disposed on the strip light-guiding elements 30. Each strip light-guiding element 30 has a light-inputting surface 300 facing each light-emitting module 21, a reflective surface 301 and a light-outputting surface 302. Each strip reflective element 31 is disposed on the reflective surface 301 of each strip light-guiding element 30, and the light-outputting surface 302 of each strip light-guiding element 30 is a rough surface for destroying total reflection. In addition, each strip light-guiding element 30 has a plurality of micro concave structures formed on the rough surface thereof by etching; alternatively the rough surface of each strip light-guiding element 30 may be an atomization surface. For example, the number of the strip light-guiding-element 30 and the number of the strip reflective element 31 are three, and the three strip guiding-elements 30 are adjacent to each other. Each strip reflective element 31 is a plate-shaped or U-shaped reflective sheet (as shown in the first embodiment) for covering the reflective surface 301 of each strip light-guiding element 30. Hence, the strip light-guiding unit 3 has a receiving space 303 between the strip light-guiding elements 30, and the strip reflective elements 31 face the receiving space 303.

Besides, the cover unit 4 has a light-permitting cover 40 coupled with the substrate unit 1 for selectively covering the light-emitting unit 2 and the strip light-guiding unit 3. In other words, the light-permitting cover 40 may be used to fully cover the light-emitting unit 2 and the strip light-guiding unit 3 (as shown in FIG. 2C) or cover one part of the strip light-guiding unit 3. Moreover, the light-permitting cover 40 may be a transparent cover or an atomized cover. For example, the light-permitting cover 40 is an atomized cover, thus an rough structure 400 can be formed on the outer surface or the inner surface of the light-permitting cover 40. The rough structure 400 can be formed on the whole outer (or inner) surface or one part of the outer (or inner) surface to make the outer (or inner) surface form a rough surface.

In addition, the light-emitting device of the first embodiment further includes a fixing unit 5 that has at least one fixing element 50 for tightly coupling the light-permitting cover 40 with the substrate unit 1, and the fixing element 50 has an opening 500 and the light-permitting cover 40 passes through the opening 500

Moreover, the light-emitting device of the first embodiment further includes a positioning unit 6 that has a positioning element 60 passing through the circuit substrate 20, the substrate body 10 and heat-dissipating element 11 in sequence and screwed to the conductive structure 12, thereby the heat-dissipating element 11 is positioned on the substrate body 10.

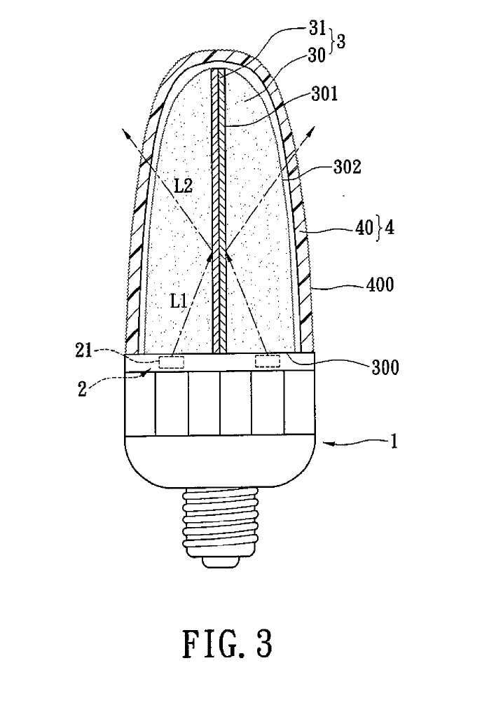

Referring to FIG. 3, the second embodiment of the instant disclosure provides a light-emitting device for increasing light-emitting efficiency by destroying total reflection, including a substrate unit 1, a light-emitting unit 2, a strip light-guiding unit 3 and a cover unit 4.

The substrate unit 1 has a substrate body 10, a heat-dissipating element 11 disposed on a bottom side of the substrate body 10 and a conductive structure 12 disposed on a bottom side of the heat-dissipating element 11 and electrically connected to the light-emitting unit 2. In addition, the heat-dissipating element 11 has a heat-dissipating body 110 and a plurality of heat-dissipating fins 111 coupled with the heat-dissipating body 110 and disposed around the heat-dissipating body 110, and the heat-dissipating fins 111 may be integrated with the heat-dissipating body 110 to form a single piece heat-dissipating structure.

Moreover, the light-emitting unit 2 has a plurality of light-emitting modules 21 disposed on the substrate unit 1. For example, the light-emitting unit 2 has a circuit substrate 20 disposed on the substrate unit 1, and each light-emitting module 21 has at least one LED (Light Emitting Diode) electrically connected to the circuit substrate 20. In other words, the light-emitting module 21 may be disposed on and electrically connected to the circuit substrate 20, and each light-emitting module 21 may be a single LED or composed of many LEDs.

The difference between the second embodiment and the first embodiment is that: in the second embodiment, the numbers of the strip light-guiding-element 30 and the strip reflective element 31 both are two, the two strip guiding-elements 30 are adjacent to each other, and the light-outputting surface 302 of each strip light-guiding element 30 is a rough surface that gradually approaches the reflective surface 301 from top to bottom. In addition, the two strip reflective elements may be coupled with each other or separated from each other by a predetermined distance, and each strip reflective element 31 is a plate-shaped reflective sheet for covering the reflective surface 301 of each strip light-guiding element 30.

For example, the light-emitting unit 2 has a plurality of light-emitting module 21 disposed on the substrate unit 1 for generating first light beams L1. Each strip light-guiding element 30 has a light-inputting surface 300 facing each light-emitting module 21 for receiving the first light beams L1, a reflective surface 301 for reflecting the first light beams L1 to from second light beams L2 and a light-outputting surface 302. Each strip reflective element 31 is disposed on the reflective surface 301 of each strip light-guiding element 30, and the light-outputting surface 302 is a rough surface for guiding the second light beams L2 to pass through the light-permitting cover 40 and project outwards.

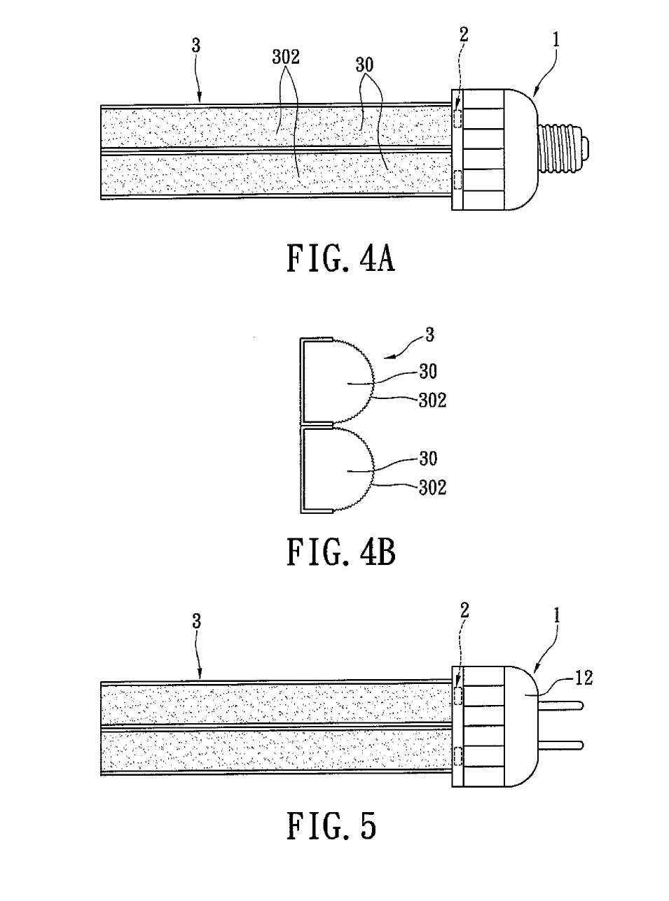

Referring to FIGS. 4A and 4B, the third embodiment of the instant disclosure provides a light-emitting device for increasing light-emitting efficiency by destroying total reflection, including a substrate unit 1, a light-emitting unit 2, a strip light-guiding unit 3 and a cover unit (not shown).

The substrate unit 1 has a substrate body 10, a heat-dissipating element 11 disposed on a bottom side of the substrate body 10 and a conductive structure 12 disposed on a bottom side of the heat-dissipating element 11 and electrically connected to the light-emitting unit 2. In addition, the heat-dissipating element 11 has a heat-dissipating body 110 and a plurality of heat-dissipating fins 111 coupled with the heat-dissipating body 110 and disposed around the heat-dissipating body 110, and the heat-dissipating fins 111 may be integrated with the heat-dissipating body 110 to form a single piece heat-dissipating structure.

Moreover, the light-emitting unit 2 has a plurality of light-emitting modules 21 disposed on the substrate unit 1. For example, the light-emitting unit 2 has a circuit substrate 20 disposed on the substrate unit 1, and each light-emitting module 21 has at least one LED (Light Emitting Diode) electrically connected to the circuit substrate 20. In other words, the light-emitting module 21 may be disposed on and electrically connected to the circuit substrate 20, and each light-emitting module 21 may be a single LED or composed of many LEDs.

The difference between the third embodiment and the first embodiment is that: in the third embodiment, the strip light-guiding elements 30 are adjacent to each other and arranged on the same plane, and the light-outputting surfaces 302 of the strip light-guiding elements 30 face the same direction as shown in FIG. 4B.

Referring to FIG. 5, the fourth embodiment of the instant disclosure provides a light-emitting device for increasing light-emitting efficiency by destroying total reflection, including a substrate unit 1, a light-emitting unit 2, a strip light-guiding unit 3 and a cover unit (not shown).

The substrate unit 1 has a substrate body 10, a heat-dissipating element 11 disposed on a bottom side of the substrate body 10 and a conductive structure 12 disposed on a bottom side of the heat-dissipating element 11 and electrically connected to the light-emitting unit 2. In addition, the heat-dissipating element 11 has a heat-dissipating body 110 and a plurality of heat-dissipating fins 111 coupled with the heat-dissipating body 110 and disposed around the heat-dissipating body 110, and the heat-dissipating fins 111 may be integrated with the heat-dissipating body 110 to form a single piece heat-dissipating structure.

Moreover, the light-emitting unit 2 has a plurality of light-emitting modules 21 disposed on the substrate unit 1. For example, the light-emitting unit 2 has a circuit substrate 20 disposed on the substrate unit 1, and each light-emitting module 21 has at least one LED (Light Emitting Diode) electrically connected to the circuit substrate 20. In other words, the light-emitting module 21 may be disposed on and electrically connected to the circuit substrate 20, and each light-emitting module 21 may be a single LED or composed of many LEDs.

The difference between the fourth embodiment and the third embodiment is that the fourth embodiment uses another type of substrate unit 1 that has another type of conductive structure 12.

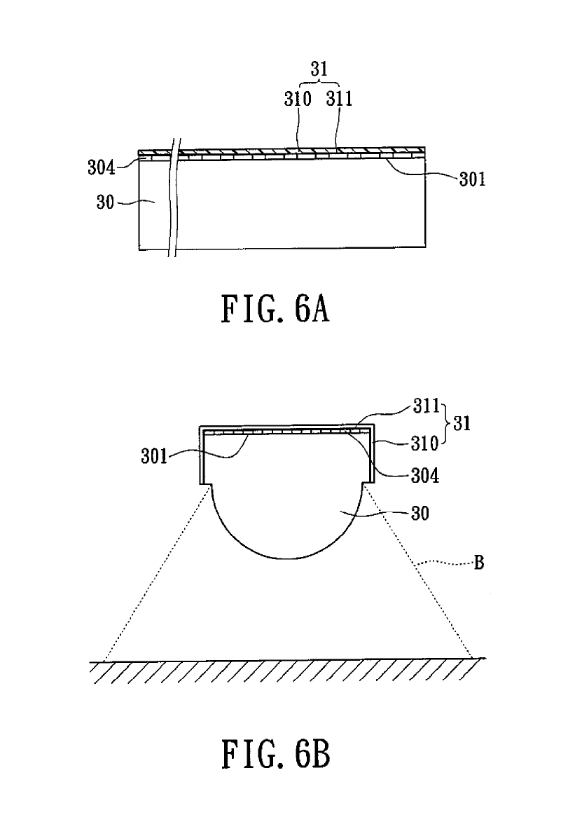

Referring to FIGS. 6A and 6B, the fifth embodiment of the instant disclosure provides a strip light-guiding unit 3 and a strip reflective element 31. The strip light-guiding unit 3 has a strip light-guiding element 30 and a plurality of light-guiding microstructures 304 disposed on a top side of the strip light-guiding element 30 and separated from each other by a predetermined distance, and each light-guiding microstructure 304 has a first reflective index. For example, the light-guiding microstructures 304 may be projected on the top side of the strip light-guiding element 30, and the light-guiding microstructures 304 may be convex dot-shaped light-guiding microstructures that are integratedly formed on the top side of the strip light-guiding element 30 or are formed on the top side of the strip light-guiding element 30 by other forming method according to different requirements. In other words, each strip light-guiding element has a plurality of light-guiding microstructures 304 formed on the reflective surface thereof and covered by each strip reflective element 31.

The strip reflective element 31 has a reflective body 310 corresponding to the strip light-guiding element 30 and a reflective layer 311 formed on an inner surface of the reflective body 310. In addition, the strip reflective element 31 covers one part of the strip light-guiding element 30 (the top part of the strip light-guiding element 30 is covered by the strip reflective element 31 as shown in FIG. 6B). The light-guiding microstructures 304 are disposed between the strip light-guiding element 30 and the reflective layer 311, and the reflective layer 311 has a second reflective index that is different from the first reflective index. Hence, the first reflective index of the light-guiding microstructures 304 is different from the second reflective index of the reflective layer 311. However, the instant disclosure can add other light-guiding microstructures with another reflective index different from the first reflective index and the second reflective index between the strip light-guiding element 30 and the reflective layer 311.

Referring to FIG. 6B, light beams generated by the light-emitting unit 2 are guided by the stripped light-guiding unit 3 and reflected by the strip reflective element 31 to form a downward light-projecting area B that has an extensive illumination range. Hence, the instant disclosure has an extensive illumination range than the prior art.

In conclusion, one embodiment of the instant disclosure provides a light-emitting device for increasing light-emitting efficiency by destroying total reflection, including: a substrate unit, a light-emitting unit, a strip light-guiding unit and a cover unit. The light-emitting unit has a plurality of light-emitting modules disposed on the substrate unit. The strip light-guiding unit has a plurality of strip light-guiding elements corresponding to the light-emitting modules and a plurality of strip reflective elements respectively disposed on the strip light-guiding elements. Each strip light-guiding element has a light-inputting surface facing each light-emitting module, a reflective surface and a light-outputting surface, each strip reflective element is disposed on the reflective surface of each strip light-guiding element, and the light-outputting surface is a rough surface for destroying total reflection. The cover unit has a light-permitting cover coupled with the substrate unit for selectively covering the light-emitting unit and the strip light-guiding unit.

Another embodiment of the instant disclosure provides a light-emitting device for increasing light-emitting efficiency by destroying total reflection, including: a substrate unit, a light-emitting unit, a strip light-guiding unit and a cover unit. The light-emitting unit has a plurality of light-emitting modules disposed on the substrate unit for generating first light beams. The strip light-guiding unit has a plurality of strip light-guiding elements corresponding to the light-emitting modules and a plurality of strip reflective elements respectively disposed on the strip light-guiding elements. The cover unit has a light-permitting cover coupled with the substrate unit for selectively covering the light-emitting unit and the strip light-guiding unit. Each strip light-guiding element has a light-inputting surface facing each light-emitting module, a reflective surface for reflecting the first light beams to from second light beams and a light-outputting surface, each strip reflective element is disposed on the reflective surface of each strip light-guiding element, and the light-outputting surface is a rough surface for guiding the second light beams to pass through the light-permitting cover and project outwards.

For example, the substrate unit has a substrate body, a heat-dissipating element disposed on a bottom side of the substrate body and a conductive structure disposed on a bottom side of the heat-dissipating element and electrically connected to the light-emitting unit, and the heat-dissipating element has a heat-dissipating body and a plurality of heat-dissipating fins coupled with the heat-dissipating body and disposed around the heat-dissipating body. The light-emitting unit has a circuit substrate disposed on the substrate unit, and each light-emitting module has at least one LED electrically connected to the circuit substrate. The numbers of the strip light-guiding element and the strip reflective element are two, the two strip light-guiding elements are adjacent to each other, and the two strip reflective elements face each other. The strip light-guiding elements are adjacent to each other, the strip light-guiding unit has a receiving space between the strip light-guiding elements, and the strip reflective elements face the receiving space. The strip light-guiding elements are adjacent to each other and arranged on the same plane, and the light-outputting surfaces of the strip light-guiding elements face the same direction. Each strip light-guiding element has a plurality of micro concave structures formed on the rough surface thereof by etching. Each strip light-guiding element has a plurality of light-guiding microstructures formed on the reflective surface thereof and covered by each strip reflective element. Each strip reflective element is a plate-shaped or U-shaped reflective sheet for covering the reflective surface of each strip light-guiding element. The light-emitting device further comprises a fixing unit having at least one fixing element for tightly coupling the light-permitting cover with the substrate unit, wherein the at least one fixing element has an opening and the light-permitting cover passes through the opening, and the light-permitting cover has an rough structure formed on the outer surface or the inner surface thereof.

Because the light-outputting surface of each strip light-guiding element may be a rough surface for destroying total reflection, the light-emitting efficiency of the light-emitting device of the instant disclosure may be increased by destroying total reflection. For example, each strip light-guiding element has a plurality of micro concave structures formed on the rough surface thereof by etching; alternatively the rough surface of each strip light-guiding element may be an atomization surface.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A light-emitting device, comprising:
a substrate unit;
a light-emitting unit having a plurality of light-emitting modules disposed on the substrate unit;
a strip light-guiding unit having a plurality of strip light-guiding elements corresponding to the light-emitting modules and a plurality of strip reflective elements respectively disposed on the strip light-guiding elements, wherein each strip light-guiding element has a light-inputting surface facing each light-emitting module, a reflective surface and a light-outputting surface, wherein each strip reflective element is disposed on the reflective surface of each strip light-guiding element, and the light-outputting surface comprises a rough surface for destroying total reflection; and
a cover unit having a light-permitting cover coupled with the substrate unit for selectively covering the light-emitting unit and the strip light-guiding unit.

2. The light-emitting device as claimed in claim 1, wherein the substrate unit has a substrate body, a heat-dissipating element disposed on a bottom side of the substrate body and a conductive structure disposed on a bottom side of the heat-dissipating element and electrically connected to the light-emitting unit, and the heat-dissipating element has a heat-dissipating body and a plurality of heat-dissipating fins coupled with the heat-dissipating body and disposed around the heat-dissipating body.

3. The light-emitting device as claimed in claim 1, wherein the light-emitting unit has a circuit substrate disposed on the substrate unit, and each light-emitting module has at least one LED electrically connected to the circuit substrate.

4. The light-emitting device as claimed in claim 1, wherein the numbers of the strip light-guiding element and the strip reflective element are two, the two strip light-guiding elements are adjacent to each other, and the two strip reflective elements face each other.

5. The light-emitting device as claimed in claim 1, wherein the strip light-guiding elements are adjacent to each other, the strip light-guiding unit has a receiving space between the strip light-guiding elements, and the strip reflective elements face the receiving space.

6. The light-emitting device as claimed in claim 1, wherein the strip light-guiding elements are adjacent to each other and arranged on the same plane, and the light-outputting surfaces of the strip light-guiding elements face the same direction.

7. The light-emitting device as claimed in claim 1, wherein each strip light-guiding element has a plurality of micro concave structures formed on the rough surface thereof by etching.

8. The light-emitting device as claimed in claim 1, wherein each strip light-guiding element has a plurality of light-guiding microstructures formed on the reflective surface thereof and covered by each strip reflective element.

9. The light-emitting device as claimed in claim 1, wherein each strip reflective element is a plate-shaped or U-shaped reflective sheet for covering the reflective surface of each strip light-guiding element.

10. The light-emitting device as claimed in claim 1, further comprising a fixing unit having at least one fixing element for tightly coupling the light-permitting cover with the substrate unit, wherein the at least one fixing element has an opening and the light-permitting cover passes through the opening, and the light-permitting cover has an rough structure formed on the outer surface or the inner surface thereof.

11. A light-emitting device, comprising:
a substrate unit;
a light-emitting unit having a plurality of light-emitting modules disposed on the substrate unit for generating first light beams;
a strip light-guiding unit having a plurality of strip light-guiding elements corresponding to the light-emitting modules and a plurality of strip reflective elements respectively disposed on the strip light-guiding elements; and
a cover unit having a light-permitting cover coupled with the substrate unit for selectively covering the light-emitting unit and the strip light-guiding unit;
wherein each strip light-guiding element has a light-inputting surface facing each light-emitting module, a reflective surface for reflecting the first light beams to from second light beams and a light-outputting surface, each strip reflective element is disposed on the reflective surface of each strip light-guiding element, and the light-outputting surface is a rough surface for guiding the second light beams to pass through the light-permitting cover and project outwards.

12. The light-emitting device as claimed in claim 11, wherein the substrate unit has a substrate body, a heat-dissipating element disposed on a bottom side of the substrate body and a conductive structure disposed on a bottom side of the heat-dissipating element and electrically connected to the light-emitting unit, and the heat-dissipating element has a heat-dissipating body and a plurality of heat-dissipating fins coupled with the heat-dissipating body and disposed around the heat-dissipating body.

13. The light-emitting device as claimed in claim 11, wherein the light-emitting unit has a circuit substrate disposed on the substrate unit, and each light-emitting module has at least one LED electrically connected to the circuit substrate.

14. The light-emitting device as claimed in claim 11, wherein the numbers of the strip light-guiding element and the strip reflective element are two, the two strip light-guiding elements are adjacent to each other, and the two strip reflective elements face each other.

15. The light-emitting device as claimed in claim 11, wherein the strip light-guiding elements are adjacent to each other, the strip light-guiding unit has a receiving space between the strip light-guiding elements, and the strip reflective elements face the receiving space.

16. The light-emitting device as claimed in claim 11, wherein the strip light-guiding elements are adjacent to each other and arranged on the same plane, and the light-outputting surfaces of the strip light-guiding elements face the same direction.

17. The light-emitting device as claimed in claim 11, wherein each strip light-guiding element has a plurality of micro concave structures formed on the rough surface thereof by etching.

18. The light-emitting device as claimed in claim 11, wherein each strip light-guiding element has a plurality of light-guiding microstructures formed on the reflective surface thereof and covered by each strip reflective element.

19. The light-emitting device as claimed in claim 11, wherein each strip reflective element is a plate-shaped or U-shaped reflective sheet for covering the reflective surface of each strip light-guiding element.

20. The light-emitting device as claimed in claim 11, further comprising a fixing unit having at least one fixing element for tightly coupling the light-permitting cover with the substrate unit, wherein the at least one fixing element has an opening and the light-permitting cover passes through the opening, and the light-permitting cover has an rough structure formed on the outer surface or the inner surface thereof.
